(19) United States
(12) Patent Application Publication
(10) Pub. No.: US 2008/0126251 A1
(43) Pub. Date: May 29, 2008

(54) SYSTEM AND METHOD FOR UTILIZING A PORTABLE NETWORK DEVICE TO INITIATE AND AUTHORIZE A PAYMENT TRANSACTION

(76) Inventor: Tomas Karl-Axel Wassingbo, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/533,794

(22) Filed: Sep. 21, 2006

(51) Int. Cl. G06Q 20/00; G06F 17/30

(52) U.S. Cl. 705/44; 705/39

(57) ABSTRACT

A portable network device authorizes a payment services system to execute a payment transaction from a payer account associated with the portable network device to a merchant's payee account. The portable network device comprises a network communication system, a user interface, and a payment application. The payment application obtains a merchant ID code associated with a position of the portable network device. The merchant ID code identifies the merchant's payee account. The payment application drives the user interface of the portable network device to obtain user confirmation of a payment transaction to the merchant's payee account and drives the network communication system to authorize the payment services system to execute the payment transaction from the payer account associated with the portable network device to the merchant's payee account. In one embodiment, a receiver may detect a local broadcast of the merchant ID code. In this embodiment, the payment application obtains the merchant ID code associated with the position of the portable network device by determining the merchant ID code of the local broadcast detected by the receiver. In another embodiment, a GPS system may determine a position of the portable network device. In this embodiment, the payment application obtains the merchant ID code associated with the position of the portable network device by input of the position of the portable network device (as determined by the GPS system) to a look up database. The look-up database: i) associates an indicator of an area with each of a plurality of merchant ID codes; and ii) returns the merchant ID code which is associated with an area within which the portable network device is positioned.

### TECHNICAL FIELD OF THE INVENTION

The present invention relates to systems and methods for using a portable network device for initiating and authorizing a payment transaction and, in particular, systems and methods for using a portable network device for initiating and authorizing a payment transaction to a merchant when the portable network device is positioned within a limited area around the merchant's point of sale systems.

### DESCRIPTION OF THE RELATED ART

Payment for goods or services at a merchant's point of sale system typically involves the customer paying cash, writing a check, or payment by an electronic payment transaction.

The most common electronic payment transaction is the credit or charge card signature transaction processed through a credit card processing service.

Typically the customer presents a credit or charge card to the merchant. The merchant initiates an authorization request to the payment processor indicating the customer's account to be debited and the charge amount. The payment processor authorizes the payment. Upon authorization the customer's signature is captured by the merchant (on a paper charge slip or electronically) to indicate customer authorization of the debit to his or her account.

It should be appreciated that the above described technology includes the merchant (e.g. the payee) initiating the debit to the account of the customer (e.g. the payer) in a manner such that some refer to such a transaction as a “pull” transaction because the merchant is “pulling” the payment from the customer's account after receiving customer authorization in the form of the customer signature.

The primary challenge with the above described credit or charge card transactions is fraud. While the card, the account information on the card, and the customer's signature are some evidence that the customer has authority to authorize debit of the account for payment of the goods or services, counterfeit and stolen cards are easily used by unscrupulous individuals.

Even with an extremely high fraud rate, credit or charge card signature transactions remain the most popular electronic transaction for making payment at a “brick and mortar” merchants point of sale for several reasons. First, use of a credit or charge card transaction is extremely convenient for the customer. Second, signature transactions generate high fee revenue (paid by merchants) for the card issuers—to the extent that card issuers encourage consumers to use signature transactions by offering consumers cash back incentives, airline mile awards, and other incentives of financial value. Third, customers are insulated from the direct cost of the fraud because of convenient charge back processes which push the cost of fraud back to the merchant who failed to adequately detect a counterfeited or stolen card.

Despite the costs involved with accepting customer payment by signature transaction (and despite the availability of equally convenient debit card transactions which are less subject to fraud because PIN entry is required) many merchants continue to accept payment by signature transaction because, in the absence of a payment system that is more convenient and/or more rewarding for the customer than signature transaction, the transaction costs and fraud costs are outweighed by the potential loss of sales if signature transactions were not accepted.

In a separate field of technology payment processors offering services similar to the PayPal® payment processing service of Ebay Inc. of San Jose Calif. enable a payer to initiate a payment transaction to a payee (e.g. a push transaction). The payee may initiate the transaction by authentication to the payment processor via password or other secret pass code over an Internet connection. There is no need for the payer to present a charge card or other tangible item evidencing authority over the payer account.

PayPal and similar “push transaction” payment processing services have gained significant market share over signature transactions for Internet purchases because the incentives involving signature transactions for Internet purchases are significantly different than the above described incentives that encourage signature transactions for purchases at “brick and mortar” merchants. First, merchant fees are much higher and charge backs are much more common for Internet purchases because of higher fraud rates and the merchants inability to demand presentation of the physical card, capture a signature, and verify the identify of the account holder.

Second, a PayPal payment may actually be more convenient for a user in the Internet purchase because the payment may require fewer keystrokes than a signature transaction. A PayPal transaction may be initiated by a single click to launch the PayPal account authentication site pre-populated with the merchant information. The consumer then may initiate the transaction by entering only a user name (if not pre-populated by cookie), password, and payment amount. A signature transaction requires the consumer to enter his/her credit or charge card account number (usually 16 digits), expiration date, verification code, name on card (exactly as it appears on the card), and entire billing address.

Because it would be extremely inconvenient for a consumer to obtain web access and initiate a PayPal transaction while located at the point of sale of a “brick and mortar” merchant, such transactions are rarely used, if at all, for payment in such a situation.

What is needed is a system and method for enabling initiation of electronic payments at a point of sale that is an improvement over the above described systems. In more detail, what is needed is a system and method for enabling initiation of electronic payments at a point of sale that: i) does not require presentation of a credit or charge card to a merchant; ii) enables convenient use of payment processors such as PayPal or other “Push Transition” payment processors; and iii) is less susceptible to fraud than the signature transaction.

### SUMMARY

A first aspect of the present invention comprises a portable network device for authorizing a payment services system to execute a payment transaction from a payer account associated with the portable network device to a merchant's payee account.

The portable network device comprises a network communication system, a user interface, and a payment application. The payment application obtains a merchant ID code associated with a position of the portable network device. The merchant ID code identifies the merchant's payee account.

The payment application drives the user interface of the portable network device to obtain user confirmation of a payment transaction to the merchant's payee account and drives the network communication system to establish a session with the payment services system (TCP/IP connection, web services session, or other communication session) and to authorize the payment services system to execute the payment transaction from the payer account associated with the portable network device to the merchant's payee account.

In one embodiment, a receiver may detect a local broadcast of the merchant ID code. In this embodiment, the payment application obtains the merchant ID code associated with the position of the portable network device by determining the merchant ID code of the local broadcast detected by the receiver.

The receiver may be: i) a Bluetooth receiver and the broadcast may be a Bluetooth transmission; ii) an infrared receiver and the broadcast may be an infrared transmission; iii) an ultrasonic receiver and the broadcast may be an ultrasonic transmission; iv) a near field communication (NFC) receiver and the broadcast may be an NFC transmission an NFC tag or device; or v) a barcode reader and the broadcast may be in the form of a printed barcode located at the point of sale.

In another embodiment, a GPS system may determine a position of the portable network device. In this embodiment, the payment application obtains the merchant ID code associated with the position of the portable network device by input of the position of the portable network device (as determined by the GPS system) to a look up database. The look-up database: i) associates an indicator of an area with each of a plurality of merchant ID codes; and ii) returns the merchant ID code which is associated with an area within which the portable network device is positioned.

The look up database may be a remote look up database. In which case, the payment application determines the merchant ID code associated with the position of the portable network device by driving the network communication system to: i) transfer, to the remote look up database, an indication of the position of the portable network device to the remote look-up database; and ii) receive, from the remote looking up database, the merchant ID code which is associated with an area within which the portable network device is positioned.

In yet another embodiment, at least two merchant ID codes are associated with the position of the portable network device. In such embodiment, the payment application drives the user interface to: i) display an indicator of the at least two merchant ID codes; and ii) obtain user selection of a selected one of the at least two merchant ID codes. The selected one of the at least two merchant ID codes is the merchant ID code of the intended payee.

Again: i) a receiver may detect a local broadcast of the at least two merchant ID codes; and ii) the payment application may obtain the at least two merchant ID codes associated with the position of the portable network device by determining the at least two merchant ID codes of the local broadcast detected by the receiver.

Again: i) a GPS system may determine a position of the portable network device; and ii) the payment application may obtain the at least two merchant ID codes associated with the position of the portable network device by input of the position of the portable network device (as determined by the GPS system) to a look up database.

In all of the above described embodiments, driving the user interface of the portable network device to obtain user confirmation of a payment transaction to the merchant's payee account may comprise driving the user interface to display an indicator of the merchant ID code and obtaining user entry of confirmation that the indicator of the merchant ID code displayed on the user interface identifies the intended payee.

In all of the above described embodiments the payment application may further: i) drive the user interface to obtain user confirmation of a payment amount of the payment transaction; and ii) drive the network communication system to provide the payment amount to the payment service system as part of authorizing the payment services system to execute the payment transaction.

In all of the above described embodiments the payment application may further: i) drive the user interface to obtain user entry of a personal identification code; and ii) drive the network communication system to provide the personal identification code to the payment service system as part of authorizing the payment services system to execute the payment transaction.

A second aspect of the present invention comprises a method of operating a portable network device for authorizing a payment services system to execute a payment transaction from a payer account associated with the portable network device to a merchant's payee account.

The method comprises obtaining a merchant ID code associated with a position of the portable network device. The merchant ID code identifies the merchant's payee account. An indication of the merchant ID code is displayed on the portable network device and user confirmation that the displayed merchant ID code identifies an intended payee is obtained. A session is established with the payment services system (TCP/IP connection, web services session, or other) for authorizing the payment services system to execute the payment transaction from the payer account associated with the portable network device to the merchant's payee account.

In one embodiment, the merchant ID code associated with the position of the portable network device may be obtained by detecting a local broadcast of the merchant ID code. In another embodiment, the merchant ID code associated with the position of the portable network device may be obtained by: i) driving an integrated GPS system to determine a position of the portable network device; ii) driving input of the position of the portable network device to a look up database; and iii) receiving a merchant ID code from the look up database.

The look-up database: i) associates an indicator of an area to each of a plurality of merchant ID codes; and ii) returns the merchant ID code which is associated with an area within which the portable network device is positioned.

The look up database may be a remote look up database and determining the merchant ID code associated with the position of the portable network device may comprises: i) transferring, to the remote look up database, an indication of the position of the portable network device; and ii) receiving, from the remote looking up database, the merchant ID code which is associated with an area within which the portable network device is positioned.

In yet another embodiment, at least two merchant ID codes are associated with the position of the portable network device. In such embodiment, the method comprises driving the interface to: i) display an indicator of the at least two merchant ID codes; and ii) obtain user selection of a selected one of the at least two merchant ID codes. The selected one of the at least two merchant ID codes is the merchant ID code of the intended payee.

The method may comprise detecting a local broadcast of the at least two merchant ID codes. Alternatively the method may comprise input of the position of the portable network device (as determined by the GPS system) to a look up database.

In all of the above described embodiments the method may further comprise: i) driving the user interface to obtain user confirmation of a payment amount of the payment transaction; and ii) providing the payment amount to the payment service system as part of authorizing the payment services system to execute the payment transaction.

In all of the above described embodiments the method may further comprise: i) driving the user interface to obtain user entry of a personal identification code; and ii) providing the personal identification code to the payment service system as part of authorizing the payment services system to execute the payment transaction.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagram representing exemplary architecture for a system for utilizing a portable network device to initiate and authorize a payment transaction in accordance with one embodiment of the present invention;

FIG. 2 is a block diagram representing exemplary local merchant ID availability systems in accordance with one embodiment of the present invention;

FIG. 3 is a block diagram representing exemplary sub embodiment of a aspects of a system for utilizing a portable network device to initiate and authorize a payment transaction; and

FIG. 4 is a ladder diagram representing exemplary operation of a system and method for utilizing a portable network device to initiate and authorize a payment transaction in accordance with one embodiment of the present invention.

### DETAILED DESCRIPTION OF EMBODIMENTS

The term “electronic equipment” as referred to herein includes portable radio communication equipment. The term “portable radio communication equipment”, also referred to herein as a “mobile radio terminal” or “portable network device”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

Table and/or database structures represented in this application are exemplary only and intended to show the mapping of relationships between various data elements. Those skilled in the art will recognize that other table and/or database structures may store similar data elements in a manner that maintains the relationships useful for the practice of the present invention without departing from the scope of the present invention.

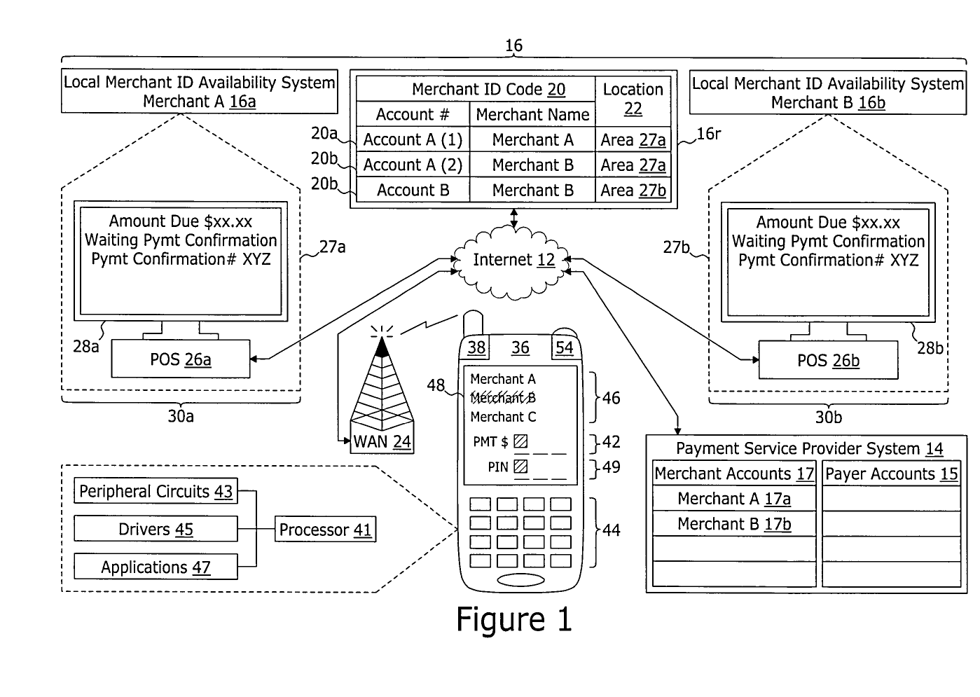

With reference to FIG. 1, exemplary architecture for a system for utilizing a portable network device 36 to initiate and authorize a payment transaction to a selected one of a plurality of merchants 30a, 30b is shown. In more detail, the system enables a user of the portable network device 36 to authorize a payment service provider system 14 to generate a payment transaction from a payer account 15 of the user to a merchant's payee account 17 utilizing a payment application operating on the portable network device 36.

The payment service provider system 14 may be any financial services provider with capabilities to generate payment transactions for purposes of debiting a payer's account and correspondingly credit a payee's account such as a bank, a credit or charge card payment processor, PayPal, or any other similar providers.

It is envisioned that the payer account may be any of a deposit account (checking or savings account), a credit card account, a Pay Pal account, or any other account associated with, or able to be debited by, the payment service provider system 14.

It is envisioned that the merchant's payee account may be any of a deposit account (checking or savings account), a merchant's credit or charge card account, a PayPal account, or any other account associated with, or able to be credited by, the payment service provider system 14.

In accordance with the exemplary system, each merchant 30a, 30b may include a traditional point of sale (POS) system 26a, 26b. A predetermined area 27a, 27b around the POS system 26a, 26b is an area within which wherein the merchant expects a customer to be located when paying for goods or services at the POS.

A merchant ID availability system 16 provides a merchant ID code 20a, 20b uniquely associated with the merchant's payee account 17a, 17b to the portable network device 36 when the portable network device 35 is positioned in the predetermined area 27a, 27b. The merchant ID availability system 16 may be a remote merchant ID availability system 16r providing merchant ID codes 20a, 20b for multiple merchants 30a, 30b via Internet or a local merchant ID availability system 16a, 16b providing merchant ID code(s) for one or more local merchants.

The local merchant ID availability system 16a, 16b generates a local broadcast of a merchant ID code 20a, 20b associated with a payee account 17a, 17b of the merchant 30a, 30b. The broadcast has a signal strength such that it can be received within a limited area 27a, 27b around the POS 26a, 26b of the merchant 30a, 30b.

The remote merchant ID availability system 16r may be a database 21 which associates each of a plurality of merchant ID codes 20a, 20b with the area 27a, 27b around the merchants POS 26a, 26b. In this embodiment, the remote merchant ID availability system 16r may receive an indication of a position of a portable network device 36 and return each of a plurality of merchant ID codes 20, 20b which are associated with an area 27 that encompasses the position of the portable network device 36.

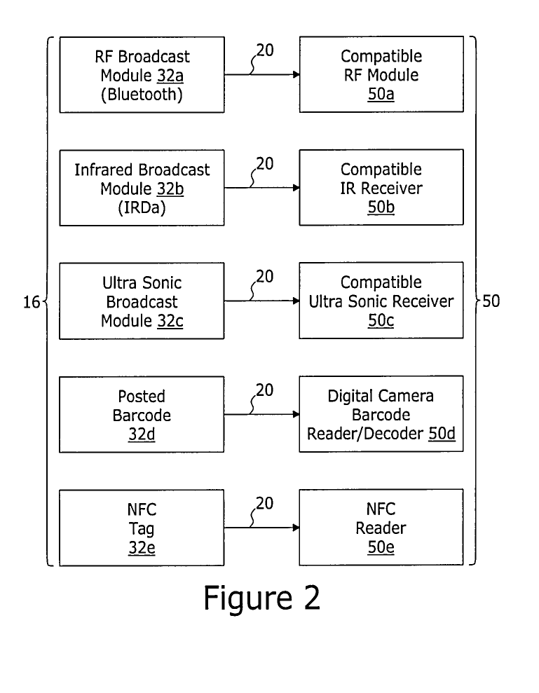

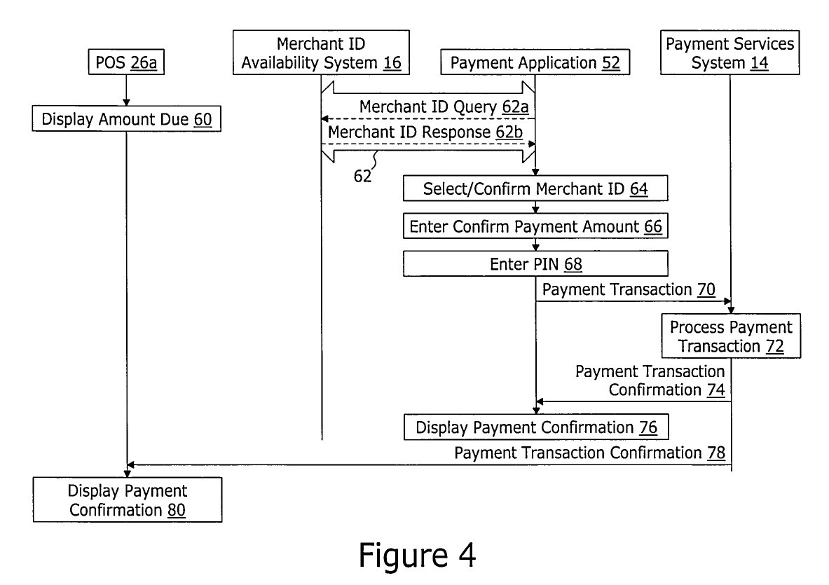

The portable network device 36 may include a processor 41 for executing applications 47 and drivers 45 for peripheral circuits 43. The peripheral circuits 43 include a network communication system 38 for internet access through a wide area network communication services provider 24 (e.g. mobile telephone service provider), a GPS system 54 for enabling the portable network device 36 to determine its position, a receiver 50 (Discussed with respect to FIG. 2) for enabling the portable network device 36 to detect a local broadcast of a merchant ID code 20, and a user interface which may include a display 48 and a keypad 44. The drivers 45 include applicable driver code for driving operation of each of the peripheral circuits 43. The applications include a payment application 52 (Discussed with respect to FIG. 4) for authorizing a payment transaction in accordance with an embodiment of the present invention as well as applicable applications for other functions of the portable network device such as a mobile telephone application and typical PDA applications such as email, web browsing, contact book, and other known applications.

Turning briefly to FIG. 2, in one exemplary embodiment, the local merchant ID availability system 16 may generate be a wireless radio frequency broadcast of the merchant ID code 20. For example a merchant's Bluetooth transceiver 32a may accept connections from a corresponding Bluetooth transceiver 50a in a customer's portable network device 36 and, through the Bluetooth connection, provide the merchant ID code 20 to the customer's portable network device 36.

In another exemplary embodiment, the local merchant ID availability system may generate an infrared broadcast of the merchant ID code 20. For example a merchant's IRDA transmitter 32b may broadcast the merchant ID code 20 for reception by an IRDA receiver 50b in the customer's portable network device 36.

In another exemplary embodiment, the local merchant ID availability system 16 may generate an ultrasonic broadcast of the merchant ID code 20. For example a merchant's ultrasonic transmitter 32c may broadcast the merchant ID code 20 for reception by an ultrasonic receiver 50c in the customer's portable network device 36.

In another exemplary embodiment, the local merchant ID availability system 16 may broadcast the merchant ID code 50 by way of representing the merchant ID code 50 as a printed barcode 32d posted within the area within the merchant expects to receive payment from customers. A barcode reader 50d (e.g a barcode reader or a digital camera with software for functioning as a bar code reader) within the customer's portable network device 36 may be used for obtaining the merchant ID 20 from the barcode 32d.

In another exemplary embodiment, the local merchant ID availability system 16 may generate a radio frequency identification (RFID) broadcast or near field communication (NFC) broadcast of the merchant ID code 20. For example a merchant's NFC tag or other NFC device 32e may broadcast the merchant ID code 20 for reception by a NFC receiving device in the customer's portable network device 36.

It should be appreciated that the above described embodiments of a local merchant ID availability system 16 are exemplary only and other systems may be used for making the merchant ID 20 available to a portable network device 36 within the area within the merchant expects to receive payments from customers.

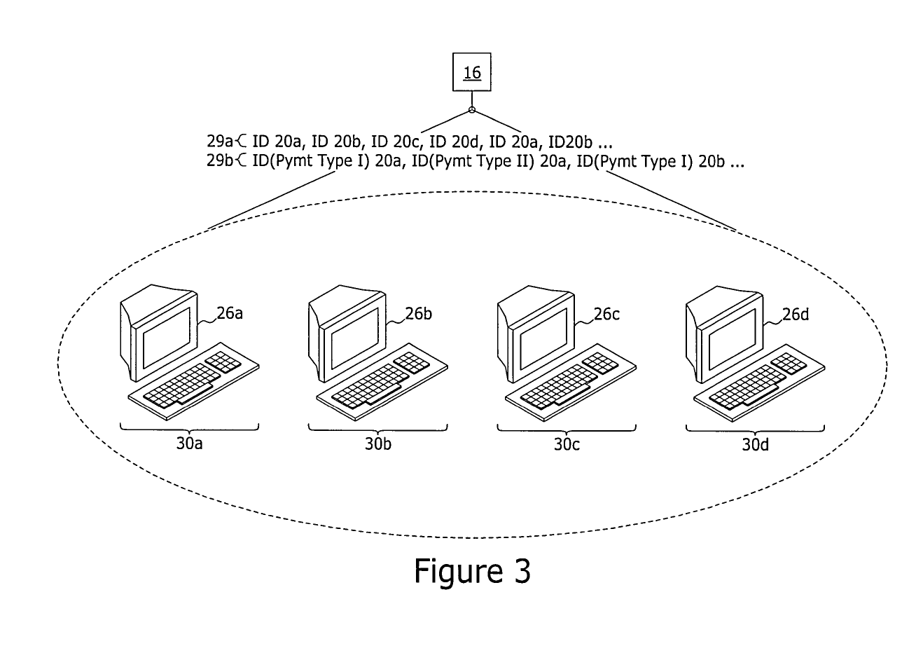

Turning briefly to FIG. 3, two sub embodiments of a local merchant ID availability system are represented. In a first sub embodiment, it is envisioned that a plurality of merchants 30a-30d, each with a respective POS system 26a-26d, are closely located, for example in a mall or crowded public square. A single local merchant ID availability system 16 may generate a broadcast signal 29a (using any of the systems discussed with respect to FIG. 2) which include a merchant ID code for each of the merchants 30a-30d within the area. For example, the broadcast signal 20a represents the merchant ID codes 20a-20d for each merchant 30a-30d within the predetermined area 27 which encompasses all of the POS systems 26a-26d. This enables a portable network device 36 within the area 27 to obtain the merchant ID code 20a-20d for each merchant within the area 27.

In a second sub embodiment, it is envisioned that a merchant 30 may accept multiple payment types, each from a separate payment service provider system 14 (FIG. 1). In which case, the local merchant ID availability system 16 may generate a broadcast signal 29b (using any of the systems discussed with respect to FIG. 2) which includes a separate merchant code for each of the multiple payment types. For example, broadcast signal 29b represents two payment types for merchant 30a (payment ID codes 20a) and one payment type for merchant 30b (payment ID code 20b). This enables a portable network device 36 within the area 27 to obtain the merchant ID code for each payment type accepted by each merchant within the area 27.

Returning to FIG. 1, the remote merchant ID availability system 16r may be a database 21 which associates each of a plurality of merchant ID codes 20a, 20b with the area 27a, 27b around the merchants POS 26a, 26b. In this embodiment, a portable network device 36 may include a GPS receiver 54 for determining its own position. The portable network device 36 may obtain a merchant ID code 20 by sending an indication of its position to the remote merchant ID availability system 16r and receiving a response which includes a merchant ID code 20 associated with an area 27 that encompasses the position of the portable network device 36.

It should be appreciated that accuracy limitations of GPS measurements and situations wherein multiple merchants are closely located (such as in a mall or a crowded public square), a query for a merchant ID code from a portable network device 36 may result in the remote merchant ID availability system 16r returning multiple merchant ID codes 20. The multiple merchant ID codes 20 would be for all merchants 30 for which the user of the portable network device 36 may desire to make payments based on a range around the position of the portable network device 36.

Further, in a sub embodiment wherein a merchant, merchant 30a for example, accepts multiple payment types from multiple payment service provider systems 14, the database 21 may associate each of multiple merchant ID codes 20a (each for a different payment type) with the area 27a.

FIG. 4 is a ladder diagram represents exemplary operation of the system for a user of the portable network device 36 makes a purchase from a merchant (merchant 30a for example). Turning to FIG. 4 in conjunction with FIG. 1, the merchant 30a totals the user's sale on the POS system 26a in a traditional manner.

Step 60 represents: i) a display of an amount due from the user on the merchant's POS system 26a in a traditional manner; and ii) the merchant communicating the amount due to the user in a traditional manner such as by making the display of amount due visible to the user or by verbally notifying the user of the amount due.

Arrow 62 represents a payment application 52 on the user's portable network device 36 obtaining one or more merchant IDs from a merchant ID availability system 16.

In more detail, if the merchant ID availability system 16a is a local merchant ID availability system 16a, arrow 62 may represent the payment application 52 of the portable network device 36 obtaining one or more merchant ID codes from a local communication system 50 (FIG. 2) which detects the broadcast of a merchant ID code within the area 27a (or reading of the barcode posted within area 27a).

If the merchant ID availability system 16 is a remote ID availability system 16b, arrow 62 may represent the portable network device 36 utilizing an internal GPS system for determining its position and generating a merchant ID query 62a (identifying the position of the portable network device 36) to the remote merchant ID availability system 16b and receiving a merchant ID response 62b identifying one or more merchant ID codes associated with the position of the portable network device 36.

The merchant ID query 62a may comprise the portable network device 36a establishing a TCP/IP connection or a simple object access protocol (SOAP) messaging web services session using with the remote merchant ID availability system 16r through a combination of the Internet 12 and the wide area network service provider 24 servicing the portable network device 36. The merchant ID response 62b may correspondingly be provided through the TCP/IP connection or through SOAP messaging compatible with the web services session.

Step 64 represents the payment application 52 of the portable network device 36 obtaining user selection or confirmation of the merchant ID code. In more detail, the payment application 52 drives a display of a representation of each of the one or more merchant ID codes 46, such as the merchant's name, on a display screen 40 of the portable network device 36 (FIG. 1). The user is prompted to select the one of the plurality of merchants to which the payment is to be made. In the exemplary embodiment, each of the merchant's names is displayed in a scroll bar 46 for user selection of the intended payee by use of a highlight bar driven by the key pad 44 of the portable network device 36.

Step 66 represents the payment application 52 of the portable network device 36 obtaining user entry and confirmation of the payment amount. In more detail, the payment application 52 drives a display of a prompt 48 for entry and confirmation of the payment amount and user entry of the payment amount is by use of the key pad 44 of the portable network device 36.

Step 68 represents the payment application 52 of the portable network device 36 obtaining user entry and confirmation of other information needed for generating a payment transaction to the payment service provider system 14 such as authentication information such as a personal identification code (e.g. PIN). In more detail, the payment application 52 drives a display of a prompt 49 for entry of the personal identification code. Entry of the personal identification code is by use of the key pad 44 of the portable network device 36.

The payment application 52 then generates a payment transaction 70 to the payment service provider system 14. In the exemplary embodiment, the payment transaction may comprise establishing a TCP/IP connection or a simple object access protocol (SOAP) messaging web services session using with the payment service provider system 14 through a combination of the Internet 12 and the wide area network service provider 24 (e.g. mobile telephone service provider) servicing the portable network device. The payment transaction may comprise identification of the payee account to be debited (which may be stored locally on the portable network device 36 by the payment application 52) the Merchant ID code or other indication of the merchant payee account to be credited, the payment amount, and authentication such as the personal ID code of the user authorizing the payment transaction.

Step 72 represents the payment services system processing the payment transaction and generating a payment transaction confirmation 74 to the payment application 52 and generating a payment transaction confirmation 78 to the merchant's POS system 26. Each of the confirmation 74 and the confirmation 78 may be through a TCP/IP connection or by SOAP messaging compatible with an open web services session.

Step 76 represents the payment application 52 driving a display of payment confirmation message to the user on the display screen 40 of the portable network device 36 and step 80 represents the POS system 26 displaying a payment confirmation message on a display screen 28—or, alternatively, printing a paper receipt that includes the payment confirmation message. The payment confirmation message may comprise a confirmation ID code provided by the payment service provider system 14. The independent display of payment confirmation messages is for purposes of instilling confidence in both the merchant and the user that the payment has been properly processed.

It should also be appreciated that steps 74 and 76 (sending and displaying payment confirmation on the portable network device 36) and/or steps 78 and 80 (sending and displaying/printing payment confirmation at the POS 26) may be replaced and/or supplemented by the payment services system 14 sending a payment confirmation using email, SOAP messaging, or other messaging schemas.

With reference again to FIG. 1, exemplary architecture for the system provides utilizing a portable network device 36 to initiate and authorize a payment transaction at a merchant's POS in a manner that: i) does not require physical presentation of a credit or charge card at a merchant's POS; ii) enables convenient user of payment processors such as PayPal or other “Push Transaction” payment processors; and iii) is less susceptible to fraud than a traditional credit or charge signature transaction.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A portable network device for authorizing a payment services system to execute a payment transaction from a payer account to a merchant's payee account, the portable network device comprising:
a network communication system;
a user interface; and
a payment application, the payment application:
obtaining a merchant ID code associated with a position of the portable network device, the merchant ID code identifying the merchant's payee account;
driving the user interface of the portable network device to obtain user confirmation of a payment transaction to the merchant's payee account; and
driving the network communication system to establish a session with the payment services system for authorizing the payment services system to execute the payment transaction from the payer account to the merchant's payee account.

2. The portable network device of claim 1:
further comprising a receiver for detecting a local broadcast of the merchant ID code; and
the payment application obtains the merchant ID code associated with the position of the portable network device by determining the merchant ID code of the local broadcast detected by the receiver.

3. The portable network device of claim 2, wherein the receiver is a Bluetooth receiver and the broadcast is a Bluetooth transmission.

4. The portable network device of claim 2, wherein:
driving the user interface of the portable network device to obtain user confirmation of a payment transaction to the merchant's payee account comprises:
driving the user interface to display an indicator of the merchant ID code; and
obtain user entry of confirmation that the indicator of the merchant ID code displayed on the user identifies a an intended payee.

5. The portable network device of claim 4, wherein the payment application further drives the user interface to obtain user confirmation of a payment amount of the payment transaction; and
authorizing the payment services system to execute the payment transaction comprises providing the payment amount to the payment service system.

6. The portable network device of claim 5, wherein:
the payment application further drives the user interface to obtain user entry of a personal identification code; and
authorizing the payment services system to execute the payment transaction comprises providing the personal identification code to the payment service system.

7. The portable network device of claim 1, wherein:
the portable network device further comprises a GPS system for determining a position of the portable network device; and
the payment application obtains the merchant ID code associated with the position of the portable network device by input of the position of the portable network device to a look up database and receiving a merchant ID code from the look up database;
the look-up database:
associating an indicator of an area with each of a plurality of merchant ID codes; and
returning the merchant ID code which is associated with an area within which the portable network device is positioned.

8. The portable network device of claim 7, wherein:
the look up database is a remote look up database; and
the payment application determines the merchant ID code associated with the position of the portable network device by driving the network communication system to:
transferring, to the remote look up database, an indication of the position of the portable network device to the remote look-up database; and
receiving, from the remote looking up database, the merchant ID code which is associated with an area within which the portable network device is positioned.

9. The portable network device of claim 8, wherein:
driving the user interface of the portable network device to obtain user confirmation of a payment transaction to the merchant's payee account comprises:
driving the user interface to display an indicator of the merchant ID code; and
obtain user entry of confirmation that the indicator of the merchant ID code displayed on the user identifies a an intended payee.

10. The portable network device of claim 9, wherein:
the payment application further drives the user interface to obtain user confirmation of a payment amount of the payment transaction; and
authorizing the payment services system to execute the payment transaction comprises providing the payment amount to the payment service system.

11. The portable network device of claim 10, wherein:
the payment application further drives the user interface to obtain user entry of a personal identification code; and
authorizing the payment services system to execute the payment transaction comprises providing the personal identification code to the payment service system.

12. The portable network device of claim 1, wherein:
at least two merchant ID codes are associated with the position of the portable network device; and
the payment application drives the user interface to:
display an indicator of the at least two merchant ID codes; and
obtain user selection of a selected one of the at least two merchant ID codes, the selected one of the at least two merchant ID codes being the merchant ID code of the intended payee.

13. The portable network device of claim 12:
further comprising a receiver for detecting a local broadcast of the at least two merchant ID codes; and
the payment application obtains the at least two merchant ID codes associated with the position of the portable network device by determining the at least two merchant ID codes of the local broadcast detected by the receiver.

14. The portable network device of claim 12, wherein:
the portable network device further comprises a GPS system for determining a position of the portable network device; and
the payment application obtains the at least two merchant ID codes associated with the position of the portable network device by input of the position of the portable network device to a look up database and receiving the at least two merchant ID codes from the look up database;
the look-up database:
associating an indicator of an area with each of a plurality of merchant ID codes; and
returning the at least two merchant ID codes which are associated with an area within which the portable network device is positioned.

15. The portable network device of claim 14, wherein:
the look up database is a remote look up database; and
the payment application determines the at least two merchant ID codes associated with the position of the portable network device by driving the network communication system to:
transferring, to the remote look up database, an indication of the position of the portable network device to the remote look-up database; and
receiving, from the remote looking up database, the at least two merchant ID codes which are associated with an area within which the portable network device is positioned.

16. A method of operating a portable network device for authorizing a payment services system to execute a payment transaction from a payer account to a merchant's payee account, the method comprising:
obtaining a merchant ID code associated with a position of the portable network device, the merchant ID code identifying the merchant's payee account;
displaying an indication of the merchant ID code on the portable network device;
obtaining user confirmation that the indicated of the merchant ID code identifies an intended payee; and
establishing a session with the payment services system for authorizing the payment services system to execute the payment transaction from the payer account to the merchant's payee account.

17. The method of claim 16 wherein obtaining a merchant ID code associated with the position of the portable network device may comprises detecting a local broadcast of the merchant ID code.

18. The method of claim 17:
further comprising, obtaining user confirmation of a payment amount of the payment transaction; and
authorizing the payment services system to execute the payment transaction comprises providing the payment amount to the payment service system.

19. The method of claim 18:
further comprising, obtaining user entry of a personal identification code; and
authorizing the payment services system to execute the payment transaction comprises providing the personal identification code to the payment service system.

20. The method of claim 16, wherein obtaining a merchant ID code associated with a position of the portable network device comprises:
driving an integrated GPS system to determine a position of the portable network device;
driving input of the position of the portable network device to a look up database; and
receiving a merchant ID code from the look up database;
the look-up database:
associating an indicator of an area with each of a plurality of merchant ID codes; and
returning the merchant ID code which is associated with an area within which the portable network device is positioned.

21. The method of claim 20, wherein the look up database is a remote look up database; and determining the merchant ID code associated with the position of the portable network device comprises:
transferring, to the remote look up database, an indication of the position of the portable network device to the remote look-up database; and
receiving, from the remote looking up database, the merchant ID code which is associated with an area within which the portable network device is positioned.

22. The method of claim 21:
further comprising, obtaining user confirmation of a payment amount of the payment transaction; and
authorizing the payment services system to execute the payment transaction comprises providing the payment amount to the payment service system.

23. The method of claim 22:
further comprising, obtaining user entry of a personal identification code; and
authorizing the payment services system to execute the payment transaction comprises providing the personal identification code to the payment service system.

24. The method of claim 16, wherein at least two merchant ID codes are associated with the position of the portable network device and method further comprises:
displaying an indicator of the at least two merchant ID codes; and
obtaining user selection of a selected one of the at least two merchant ID codes, the selected one of the at least two merchant ID codes being the merchant ID code of the intended payee.

25. The method of claim 24 wherein obtaining the at least two merchant ID codes associated with the position of the portable network device may comprises detecting a local broadcast of the at lest two merchant ID codes.

26. The method of claim 24, wherein obtaining the at least two merchant ID codes associated with a position of the portable network device comprises:
driving an integrated GPS system to determine a position of the portable network device;
driving input of the position of the portable network device to a look up database; and
receiving the at least two merchant ID codes from the look up database;
the look-up database:
associating an indicator of an area with each of a plurality of merchant ID codes; and
returning the at least two merchant ID codes which are associated with an area within which the portable network device is positioned.
